(19) United States
(12) Patent Application Publication
(10) Pub. No.: US 2008/0065789 A1
(43) Pub. Date: Mar. 13, 2008

(54) Multi-purpose IO system

(76) Inventor: Chinyi Chiang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,480

(22) Filed: Oct. 25, 2007

Related U.S. Application Data
(62) Division of application No. 10/983,694, filed on Nov. 9, 2004.

(30) Foreign Application Priority Data
Jan. 2, 2004 (TW) 093100035

(51) Int. Cl. G06F 3/038; G06F 12/00

(52) U.S. Cl. 710/11; 711/103; 711/E12.001

(57) ABSTRACT

A multi-purpose IO system is provided, comprising a plurality of IO devices, provided with a plurality of data pins and a plurality of address pins respectively; a controller chip, comprising a plurality of controllers corresponding to the IO devices, a multiplexer with a signal mapping device, an arbitrator and a plurality of address data pins; and an address data bus, comprising a plurality of signal lines corresponding to and connected to the address data pins of the controller chip; wherein the data pins and the address pins of the IO devices are connected to the signal lines of the address data bus for electrically connecting to the controller chip.

### RELATED CASES

This application is a Divisional patent application of co-pending application Ser. No. 10/983,694, filed on 9 Nov. 2004.

### BACKGROUND OF THE INVENTION

1. Field of the Invention

The present invention generally relates to an IO (I/P and O/P) system and, more particularly, to an IO system with a multiplexer is used with a signal mapping device for reducing the necessary area of printed circuit board (PCB) layout since various IO devices are flexibly coupled with the controller chip.

2. Description of the Prior Art

With the rapid development in the IT (information technology) industry, IT products are expected to perform better in various applications—having ability in handling more data in a shorter time and user-friendly interfaces. For example, information processing operations and/or interfaces are adopted more or less in AV (audio/video) systems, communication devices and consumer products. In order for information to be communicated and/or processed between different devices and apparatuses, various IO devices are often required and installed.

At the present day, memory cards are the most commonly used memory media for information communication with other information devices and/or storing data into computers for further calculation and/or processing.

However, there have been developed various types of memory cards that have different interface specifications for information communication. In order for different types of memory cards to be used with the same information device, a suitable read/write device has to be installed on the information device so as to communicate the memory cards with the information device and store the data from the memory cards into the information device. A multi-purpose card reader has been disclosed so as to support various types of memory cards onto a printed circuit board (PCB). The multi-purpose card reader is described as illustrated in FIG. 1, comprising: a first socket 151 for adopting a first memory card 141; a second socket 153 for adopting a second memory card 143; a third socket 155 for adopting a third memory card 145; and a controller chip 12 for connecting each of the memory cards through sockets, whereby a computer 13 accesses to the memory cards.

The first socket 151 meets the specification of the first memory card 141 and is provided with data contacts D[i:0] and address contacts A[p:0] so as to be connected to data pins dat[i:0] and address pins add[p:0] of the first memory card 141, respectively. The data contacts and the address contacts are connected to a first controller 121 of the controller chip 12 through a first data bus 161 comprising (i+1) signal lines and a first address bus 181 comprising (p+1) signal lines. The second socket 153 is provided with data contacts D[j:0] and address contacts A[q:0] to be connected to a second controller 123 of the controller chip 12 through a second data bus 163 comprising (j+1) signal lines and a second address bus 183 comprising (q+1) signal lines. The data contacts and the address contacts are connected to data pins dat[j:0] and address pins add[q:0] of the second memory card 143, respectively. The third socket 153 is provided with data contacts D[k:0] and address contacts A[r:0] to be connected to a third controller 125 of the controller chip 12 through a third data bus 165 comprising (k+1) signal lines and a third address bus 185 comprising (r+1) signal lines. The data contacts and the address contacts are connected to data pins dat[k:0] and address pins add[r:0] of the third memory card 145, respectively.

The controller chip 12 is further provided with an arbitrator 129 connected to the first controller 121, the second controller 123 and the third controller 125, respectively. Each of the memory cards 141, 143, 145 is provided with an enable pin CE1, CE2 and CE3, respectively, each connected to the arbitrator 129 of the controller chip 12 through a first enable signal line 191, a second enable signal line 193, and a third enable signal line 195. The arbitrator 129 enables one of the memory cards to be accesses to and a corresponding controller through a corresponding enable signal line according to the command of the computer 13; meanwhile, the arbitrator 129 disables the other memory cards and other controllers. Therefore, the computer 13 accesses to various memory cards of different specifications through the controller chip 12 of the card reader.

The prior art reference as mentioned achieves the object that the computer successfully accesses to the memory cards of different specifications; however, the controller chip 12 has to be provided with many pins as to be connected with these memory cards. The manufacturing cost increases as the number of pins increases. Meanwhile, the area being large enough is required as to adopt these pins. Layout design thus becomes complicated because these pins, contacts and signal lines therebetween occupy a large amount of the area.

### SUMMARY OF THE INVENTION

Accordingly, it is the primary object of the present invention to provide a multi-purpose IO system, in which a controller chip and an address data bus are used to connect various IO devices.

It is a secondary object of the present invention to provide a multi-purpose IO system, in which a multiplexer is installed in the controller chip, such that each of the various IO devices is connected to the controller chip at the same set of pins so as to reduce the number of pins as well as the fabrication cost.

It is another object of the present invention to provide a multi-purpose IO system, in which a signal mapping device is installed in the multiplexer, such that each of the various IO devices is connected to the controller chip at the most proper pin so as to reduce the required printed circuit board layout area.

In order to achieve the foregoing objects, the present invention provides a multi-purpose IO system, comprising: a plurality of IO devices, each being provided with a plurality of data pins and a plurality of address pins; a controller chip, comprising a plurality of controllers corresponding to said IO devices, a multiplexer, an arbitrator and a plurality of address data pins; and an address data bus, comprising a plurality of signal lines corresponding to and connected to said address data pins of said controller chip; wherein said data pins and said address pins of said IO devices are connected to said signal lines of said address data bus so as to be electrically connected to said controller chip.

The present invention further provides a multi-purpose IO system, comprising: a plurality of IO devices, each being provided with a plurality of data pins, a plurality of address pins and a controller pin; a controller chip, comprising a plurality of controllers corresponding to said IO devices, a multiplexer, an arbitrator and a plurality of address data controller pins; and an address data bus, comprising a plurality of signal lines corresponding to and connected to said address data controller pins of said controller chip; wherein said data pins, said address pins and said controller pin of said IO devices are connected to said signal lines of said address data bus so as to be electrically connected to said controller chip.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a block circuit diagram schematically illustrating a conventional multi-purpose card reader in accordance with the prior art;

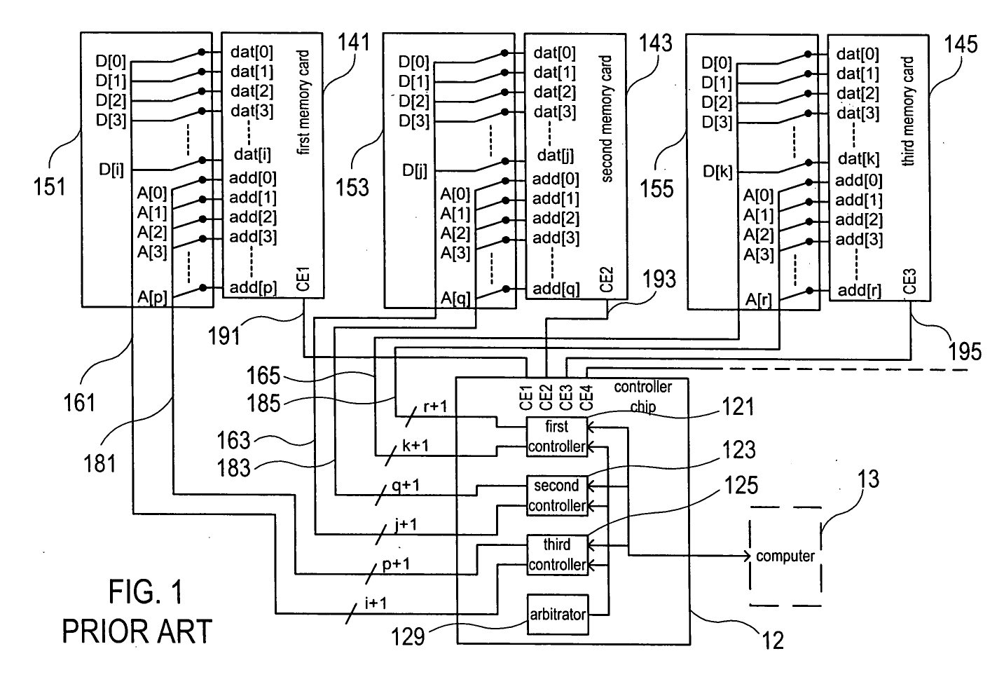

FIG. 2 is a block circuit diagram showing a multi-purpose IO system in accordance with one preferred embodiment of the present invention; and

FIG. 3 is a block circuit diagram showing a multi-purpose IO system in accordance with another embodiment of the present invention.

### DETAILED DESCRIPTION OF THE INVENTION

The present invention providing a multi-purpose IO system can be exemplified by the preferred embodiments as described hereinafter.

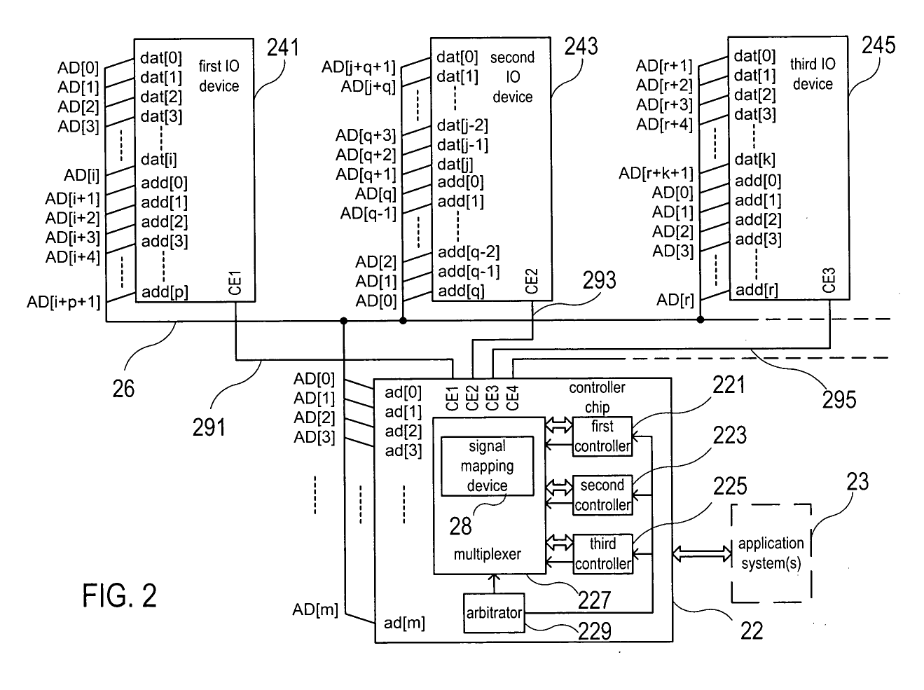

To start with, please refer to FIG. 2, which is a block circuit diagram showing a multi-purpose IO system in accordance with one preferred embodiment of the present invention. As shown in FIG. 2, the IO system of the present invention comprises: a plurality of IO devices, a controller chip 22 and an address data bus 26. In one preferred embodiment, the plurality of IO devices include a first IO device 241, a second IO device 243 and a third IO device 245. Each of the IO devices is provided with a plurality of data pins and a plurality of address pins. More particularly, the first IO device 241 is provided with data pins dat[i:0] and address pins add[p:0]; the second IO device 243 is provided with data pins dat[j:0] and address pins add[q:0]; and the third IO device 245 is provided with data pins dat[k:0] and address pins add[r:0].

The controller chip 22 comprises a first controller 221, a second controller 223 and a third controller 225 corresponding to the first IO device 241, the second IO device 243 and the third IO device 245. Each of the controllers 221 to 225 is connected to a plurality of address data pins ad[m:0] of the controller chip 22 through a multiplexer 227. The address data pins ad[m:0] is connected to the data pins and the address pins of each of the IO devices through an address data bus 26 comprising (m+1) signal lines AD[m:0] corresponding to and connected to the address data pins of the controller chip 22.

As the system operates, an arbitrator 229 connected to the multiplexer 227 and the controllers 221 to 225 is used to arbitrate so as to determine whether the first controller 221, the second controller 223 or the third controller 225 is allowed to have access to the address data pins ad[m:0] of the controller chip 22 through the multiplexer 227 during a time interval. The arbitrator 229 is connected to the first IO device 241, the second IO device 243 and the third IO device 245 through enable pins CE1, CE2 and CE3 of the controller chip 22 and a first enable signal line 291, a second enable signal line 293 and a third enable signal line 295, such that the corresponding IO devices are enabled while others are disabled when the controllers 221 to 225 have access to the address data pins. Therefore, application systems 23, such as computers or other information devices, have access to designated IO devices through the controller chip 22. The controller chip 22 only has to be provided with a maximum number of pins for an IO device. Therefore, reduction of the area of the controller chip 22 and the fabrication cost can be achieved due to reduced pins on the controller chip 22.

In the multi-purpose IO system of the present invention, a signal mapping device 28 can further be installed in the multiplexer 227. The signal mapping device 28 pre-determines the interconnections between the data pins and the address pins of the IO devices and the address data pins of the controller chip 22. Moreover, the IO devices connect the data pins and the address pins to the corresponding signal lines in the address data bus 26 according to the interconnections pre-determined by the signal mapping device 28. For example, as shown in FIG. 2, the first IO device 241 connects in forward order the data pins dat[i:0] and the address pins add[p:0] to the signal lines AD[i+p+1:0] in the address data bus 26; the second IO device 243 connects in reverse order the data pins dat[j:0] and the address pins add[q:0] to the signal lines AD[j+p+1:0] in the address data bus 26; and the third IO device 245 connects in forward order the data pins dat[k:0] to the address data pins AD[r+k+1:0] and the address pins add[r:0] to the address data pins AD[r:0]. The interconnections aforementioned can be rearranged according to practical applications. Therefore, the layout is simplified and the required area is reduced, resulting in compactness of IT products.

The signal mapping device 28 can be implemented by using circuitry such that the aforementioned interconnections are realized by switching. Moreover, the signal mapping device 28 can also be implemented by using a flash memory, an electrically erasable programmable read-only memory (EEPROM) or a non-volatile random access memory (NVRAM), where is stored a look-up table for corresponding signals whereby obtaining the interconnections between the address data pins and the pins of the IO devices. In the preferred embodiment of the present invention, the look-up table for corresponding signals can be further modified according to practical applications; and thus it allows more flexibility in designing the system.

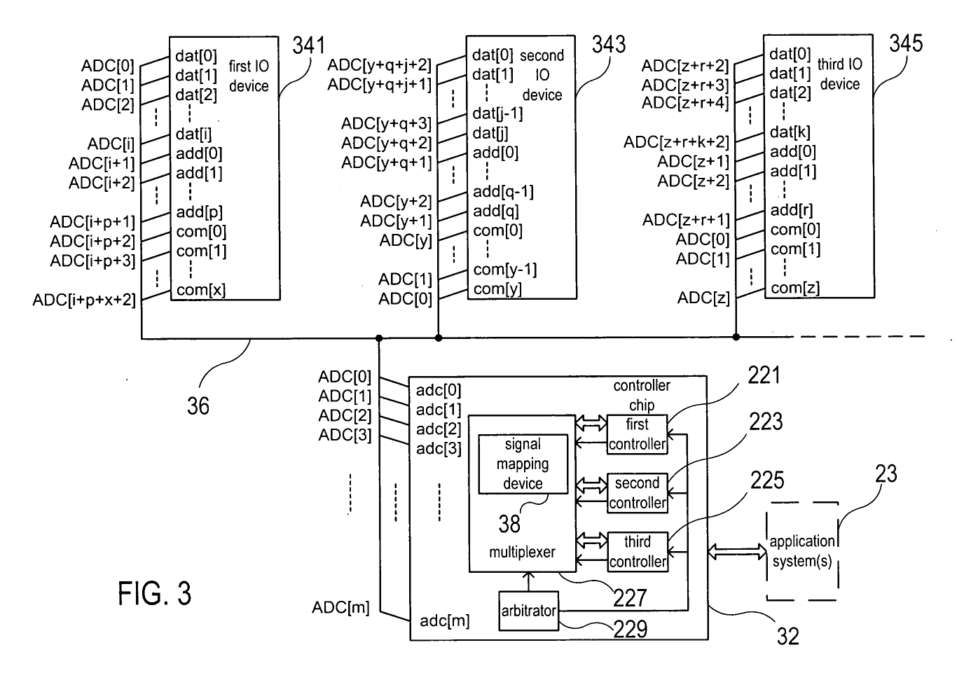

Please further refer to FIG. 3, which is a block circuit diagram showing a multi-purpose IO system in accordance with another embodiment of the present invention. As shown in the figure, the IO system is similar to that of FIG. 2. However, each of the IO devices 341, 343 and 345 further comprises at least a control pin, for example, the control pins com[x:0] of the first IO device 341, the control pins com[y:0] of the second IO device 343 and the control pins com[z:0] of the third IO device 345. The controller chip 32 is provided with a plurality of address data control pins adc [m:0], and is connected to the IO devices through the address data control bus 36 comprising a plurality of signal lines ADC[m:0].

In the present embodiment, the signal mapping device 38 adopts the interconnections between the address pins, data pins, and control pins of the IO devices and the address data control pins of the controller chip 32, thus allowing more flexibility in layout design.

In the present invention, the multi-purpose IO system can be used with card readers and/or integrated within a motherboard. It is applicable to various IO devices such as CF (Compact Flash) cards, SM (Smart Media) cards, MS's (Memory Sticks), SD (Secured Digital) cards, NAND flash memory cards, NOR flash memory cards, USB devices, parallel IDE devices, serial IDE devices, ROM's, EEPROM's, general-purpose I/O chips, etc.

According to the above discussion, it is apparent that the present invention discloses a multi-purpose IO system characterized in that a multiplexer is used with a signal mapping device so that the necessary area for circuit layout is reduced since various IO devices are flexibly coupled with the controller chip

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A multi-purpose IO system, comprising:
a plurality of IO devices provided with a plurality of data pins, a plurality of address pins and at least one control pin respectively;
a controller chip, comprising a plurality of controllers corresponding to said IO devices, a multiplexer, an arbitrator and a plurality of address data control pins; and
an address data bus, comprising a plurality of signal lines corresponding to and connected to said address data control pins of said controller chip;
wherein said data pins, said address pins and said control pin of said IO devices are connected to said signal lines of said address data control bus for electrically connecting to said controller chip.

2. The multi-purpose IO system as claimed in claim 1, wherein said multiplexer is provided with a signal mapping device.

3. The multi-purpose IO system as claimed in claim 2, wherein said signal mapping device is implemented by a circuit.

4. The multi-purpose IO system as claimed in claim 2, wherein said signal mapping device is implemented by a memory, storing a look-up table for corresponding signals.

5. The multi-purpose IO system as claimed in claim 4, wherein said memory is one selected from a group consisting of a flash memory, an electrically erasable programmable read-only memory (EEPROM) and a non-volatile random access memory (NVRAM).

6. The multi-purpose IO system as claimed in claim 4, wherein said look-up table is modified according to practical applications.

7. The multi-purpose IO system as claimed in claim 1, wherein said IO devices are selected from a group consisting of CF (Compact Flash) cards, SM (Smart Media) cards, MS's (Memory Sticks), SD (Secured Digital) cards, NAND flash memory cards, NOR flash memory cards, USB devices, parallel IDE devices, serial IDE devices, ROM's, EEPROM's and general-purpose I/O chips.

8. The multi-purpose IO system as claimed in claim 1, wherein said IO system is used with card readers.

9. The multi-purpose IO system as claimed in claim 1, wherein said IO system is integrated within a motherboard.
